(19) United States
(12) Patent Application Publication
(10) Pub. No.: US 2025/0358087 A1
(43) Pub. Date: Nov. 20, 2025

(54) NEGOTIATED TIME DIVISION DUPLEX DOWNLINK-UPLINK CONFIGURATIONS

(71) Applicant: Charter Communications Operating, LLC, St. Louis, MO (US)

(72) Inventors: Marcus Maranhao, Irvine, CA (US); Muhammad Usman Fazili, Audubon, PA (US); Phillip Babatunde Oni, Spring, TX (US)

(21) Appl. No.: 19/209,126

(22) Filed: May 15, 2025

Related U.S. Application Data
(60) Provisional application No. 63/649,134, filed on May 17, 2024.

(51) Int. Cl. H04L 5/14; H04W 72/0446

(52) U.S. Cl. CPC H04L 5/14; H04W 72/0446

(57) ABSTRACT

A first wireless base station sends, to a second wireless base station, a first message that includes an intended time division duplex (TDD) downlink (DL)-uplink (UL) configuration of the first wireless base station that identifies a first pattern of uplink timeslots and downlink timeslots that the first wireless base station proposes to utilize to communicate with one or more user equipments (UEs) in a service area of the first wireless base station. The first wireless base station receives, from the second wireless base station, a second message comprising an acceptance message that accepts the intended TDD DL-UL configuration of the first wireless base station or a rejection message that rejects the intended TDD DL-UL configuration of the first wireless base station.

### RELATED APPLICATION

This application claims priority to U.S. Provisional Patent Application No. 63/649,134, filed on May 17, 2024, entitled “NEGOTIATED TIME DIVISION DUPLEX DOWNLINK-UPLINK CONFIGURATIONS,” the disclosure of which is hereby incorporated herein by reference in its entirety.

### BACKGROUND

Two base stations in proximity to one another utilizing a time division duplex (TDD) protocol to communicate with user equipments (UEs) may encounter cross-link interference if one base station is transmitting on a downlink timeslot at the same time the other base station is receiving during an uplink timeslot.

### SUMMARY

The examples disclosed herein implement negotiated TDD DL-UL configurations between wireless base stations in relatively close proximity to one another.

In one implementation a method is provided. The method includes sending, by a first wireless base station to a second wireless base station, a first message that includes an intended time division duplex (TDD) downlink (DL)-uplink (UL) configuration of the first base station that identifies a first pattern of uplink timeslots and downlink timeslots that the first base station proposes to utilize to communicate with one or more user equipments (UEs) in a service area of the first base station. The method further includes receiving, by the first base station from the second base station, a second message comprising an acceptance message that accepts the intended TDD DL-UL configuration of the first base station or a rejection message that rejects the intended TDD DL-UL configuration of the first base station.

In another implementation a first base station is provided. The first base station includes a memory and a processor device operable to send, to a second wireless base station, a first message that includes an intended time division duplex (TDD) downlink (DL)-uplink (UL) configuration of the first base station that identifies a first pattern of uplink timeslots and downlink timeslots that the first base station proposes to utilize to communicate with one or more user equipments (UEs) in a service area of the first base station. The processor device is further operable to receive, from the second base station, a second message comprising an acceptance message that accepts the intended TDD DL-UL configuration of the first base station or a rejection message that rejects the intended TDD DL-UL configuration of the first base station.

In another implementation a non-transitory computer-readable storage medium is provided. The non-transitory computer-readable storage medium includes executable instructions operable to cause a processor device of a first wireless base station to send, to a second wireless base station, a first message that includes an intended time division duplex (TDD) downlink (DL)-uplink (UL) configuration of the first base station that identifies a first pattern of uplink timeslots and downlink timeslots that the first base station proposes to utilize to communicate with one or more user equipments (UEs) in a service area of the first base station. The instructions are further operable to cause the processor device to receive, from the second base station, a second message comprising an acceptance message that accepts the intended TDD DL-UL configuration of the first base station or a rejection message that rejects the intended TDD DL-UL configuration of the first base station.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which negotiated time division duplex (TDD) downlink (DL)-Uplink (UL) configurations may be practiced according to some implementations;

FIG. 2 is a flowchart of a method for implementing negotiated TDD DL-UL configurations according to one implementation;

FIG. 3 is a sequence diagram illustrating a message sequence for implementing negotiated TDD DL-UL configurations according to some implementations;

FIG. 4 is a sequence diagram illustrating a message sequence for implementing negotiated TDD DL-UL configurations according to another implementation; and

FIG. 5 is a block diagram of a base station 12 suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

First and second wireless base stations in proximity to one another utilizing a time division duplex (TDD) protocol to communicate with user equipments (UEs) may encounter cross-link interference if downlink (DL) timeslots of the first base station are concurrent with uplink (UL) timeslots of the second base station. This is because the transmit power of the first base station is far greater than the transmit power of the UE that is transmitting during the uplink timeslot of the second base station.

This problem will be exacerbated if technologies such as Sub-Band Full Duplex (SBFD), that splits a single frequency band into sub-bands for uplink (UL) and downlink (DL) transmissions, allowing both to happen simultaneously, and/or dynamic time division duplex (TDD), that can dynamically change UL or DL transmission directions, are implemented by radio access networks.

The examples disclosed herein implement negotiated TDD DL-UL configurations between wireless base stations in relatively close proximity to one another. A first wireless base station, such as an evolved Node B (eNodeB), a gNodeB, or the like, sends to a second wireless base station a message indicating an intended TDD DL-UL configuration that the first wireless base station intends to use to communicate with UEs that are being serviced by the first wireless base station. The intended TDD DL-UL configuration may include information identifying particular DL (e.g., time slots during which the first wireless base station will transmit information to UEs) and UL slots (e.g., time slots during which the UEs will transmit information to the first wireless base station. The first wireless base station sends the intended TDD DL-UL configuration to the second wireless base station. The second wireless base station receives the intended TDD DL-UL configuration and may respond with an acceptance message, indicating that the second base station accepts the intended TDD DL-UL configuration, or a rejection message, indicating that the second base station does not accept the intended TDD DL-UL configuration. If the second wireless base station responds with an acceptance message, the first wireless base station may then start using the intended TDD DL-UL configuration to communicate with UEs being serviced by the first wireless base station. If the second wireless base station responds with a rejection message, the first wireless base station may choose to generate a different intended TDD DL-UL configuration and repeat the process with the second wireless base station until the second wireless base station responds with an acceptance message. In this manner, the first and second wireless base stations may negotiate TDD DL-UL configurations with one another to arrive at mutually acceptable TDD DL-UL configurations that maximize utilization of both wireless base stations.

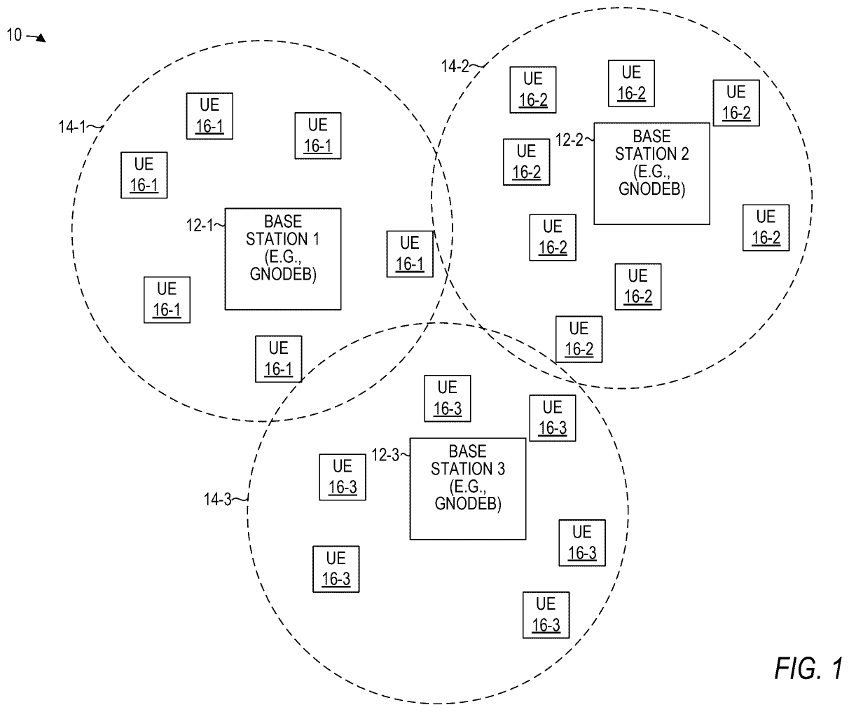

FIG. 1 is a block diagram of an environment 10 in which negotiated TDD DL-UL configurations may be practiced according to some implementations. The environment 10 includes a plurality of wireless base stations Dec. 1, 2012-3 (generally, base stations 12). The base station 12-1 has a service area 14-1 represented by a dashed circle. The UEs 16-1 within the service area 14-1 are serviced by the base station 12-1. The base station 12-2 services one or more UEs 16-2 within a service area 14-2 and the base station 12-3 services one or more UEs 16-3 within a service area 14-3. It is noted that the base stations 12 may implement multiple different cells within the corresponding service areas 14 to provide coverage within the service areas 14.

The base stations 12 may comprise, by way of non-limiting example, 5G or 6G cellular base stations that implement 3GPP standards, such as, by way of non-limiting example, 3GPP TS 38.423 (e.g., V17.4.0 Release 17) “Xn Application Protocol (XnAP)”, the contents of which are incorporated herein by reference in their entirety, but the examples disclosed herein are not limited to any particular wireless base stations and have applicability to any base stations capable of using a TDD protocol to communicate with UEs, including, by way of non-limiting example, eNodeBs, gNodeBs, or the like. The UEs may comprise any computing device operable to communicate with a base station 12, such as, by way of non-limiting example, a mobile phone, a vehicle, a laptop computing device, a tablet computing device, or the like.

At different points in time, such as, by way of non-limiting example, when the base station 12-1 initializes, or powers-up, or when new UEs 16-1 come into a service area 14-1 or leave the service area 14-1, or UEs 16-1 in the service area 14-1 need more UL slots to send data or more DL slots to receive data, the base station 12-1 may communicate to the base station 12-2 a message that includes an intended TDD DL-UL configuration of the base station 12-1 that identifies a pattern of uplink timeslots and downlink timeslots that the base station 12-1 proposes to utilize to communicate with the UE 16-1 in the service area 14-1. The base station 12-2 receives the intended TDD DL-UL configuration, analyzes its own TDD DL-UL configuration, and generates and sends to the base station 12-1 an acceptance message that accepts the intended TDD DL-UL configuration or a rejection message that rejects the intended TDD DL-UL configuration.

If the base station 12-2 rejects the intended TDD DL-UL configuration, the base station 12-2 may include in the rejection message an indication that the intended TDD DL-UL configuration is rejected. The base station 12-2 may also include in the rejection message an intended TDD DL-UL configuration or existing TDD DL-UL configuration that the base station 12-2 intends to use, or is currently using, to communicate with the UEs 16-2.

It is noted that the base station 12-1 may implement the service area 14-1 via multiple cells and, thus, may send multiple intended TDD DL-UL configurations to the base station 12-2, each intended TDD DL-UL configuration corresponding to a different cell. The base station 12-2 may accept some of the intended TDD DL-UL configurations but not others of the intended TDD DL-UL configurations.

If the base station 12-2 accepts the intended TDD DL-UL configuration, the base station 12-2 sends an acceptance message indicating that the intended TDD DL-UL configuration is accepted. The base station 12-2 may use the accepted intended TDD DL-UL configuration to derive its own intended TDD DL-UL configuration for the base station 12-2 to utilize. The base station 12-2 may include in the acceptance message an intended TDD DL-UL configuration or existing TDD DL-UL configuration that the base station 12-2 intends to use, or is using, to communicate with the UEs 16-2. Upon receipt of the acceptance message, the base station 16-1 may begin using the intended TDD DL-UL configuration which was accepted by the base station 12-2 to communicate with the UEs 16-1 in the service area 14-1.

The base station 12-1 may analyze the TDD DL-UL configuration provided by the base station 12-2 in the acceptance message and choose to respond to the base station 12-2 with an acceptance message or a rejection message. The base station 12-1 may perform the same processing with other neighboring base stations, such as the base station 12-3.

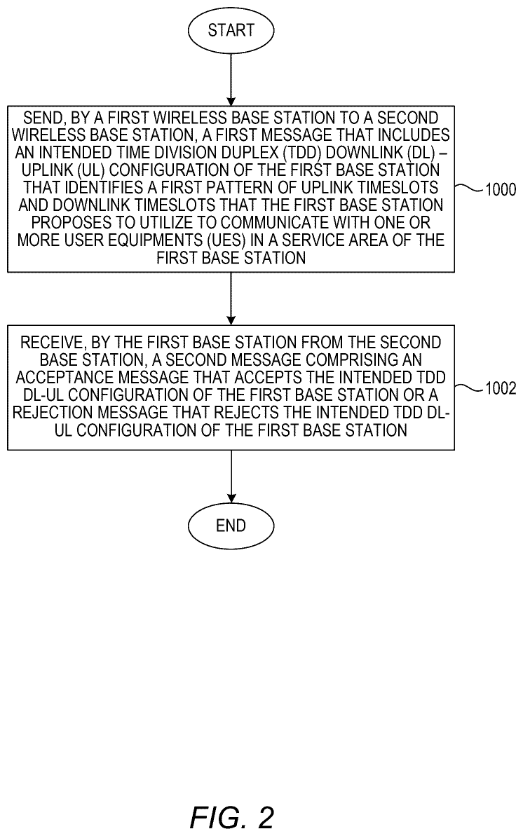

FIG. 2 is a flowchart of a method for negotiated TDD DL-UL configurations according to one implementation. FIG. 2 will be discussed in conjunction with FIG. 1. The base station 12-1 (e.g., a first wireless base station) sends to the base station 12-2 (e.g., a second wireless base station), a message that includes an intended TDD DL-UL configuration of the base station 12-1 that identifies a first pattern of uplink timeslots and downlink timeslots that the base station 12-1 proposes to utilize to communicate with the one or more UEs 20 in the service area 18 of the base station 12-1 (FIG. 2, block 1000). The base station 12-1 receives, from the base station 12-2, a message comprising an acceptance message that accepts the intended TDD DL-UL configuration of the base station 12-1 or a rejection message that rejects the intended TDD DL-UL configuration of the base station 12-1 (FIG. 2, block 1002).

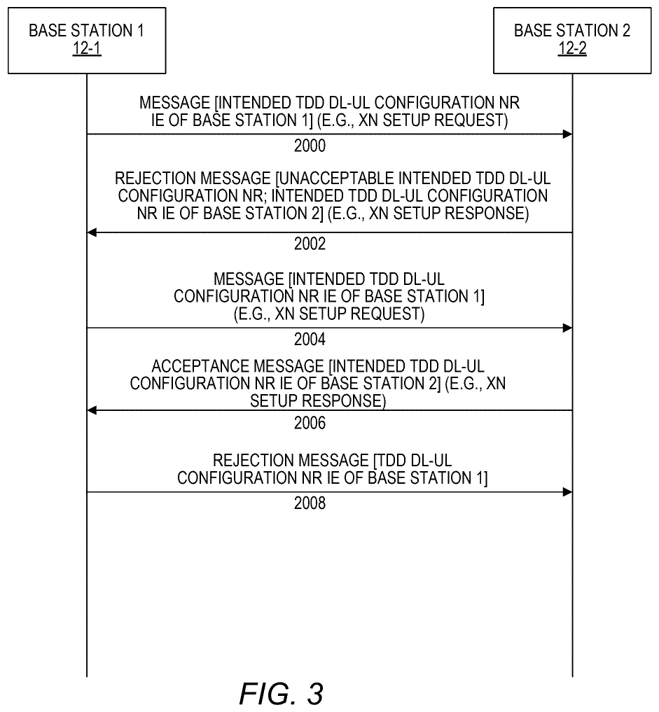

FIG. 3 is a sequence diagram illustrating a message sequence for implementing negotiated TDD DL-UL configurations according to some implementations. This example illustrates a sequence which may occur at startup, such as when a base station 12 initially is powered on, or restarts/reboots. As the base station 12-1 initializes, or shortly thereafter, the base station 12-1 sends a message to the base station 12-2 that includes an intended TDD DL-UL configuration (step 2000). In the context of cellular communications standards, such as, by way of non-limiting example, 3rd Generation Partnership Project (3GPP) standards, the message may comprise an XN SETUP REQUEST message, and the intended TDD DL-UL configuration may be communicated in an intended TDD DL-UL Configuration New Radio (NR) Information Element (IE) of the XN SETUP REQUEST message. In some implementations, each base station 12 may be required to include the intended TDD DL-UL Configuration NR IE in an XN SETUP REQUEST message as the respective base station 12 initiates. In some implementations, the base station 12-1 will not begin to use the intended TDD DL-UL configuration unless and until the base station 12-1 receives an acceptance message from the base station 12-2.

It is understood that the negotiation process may occur at times other than startup, such as, by way of non-limiting example, when the base station 12-1 needs to change the TDD UL-DL configuration of based on traffic patterns.

The base station 12-2 receives the message and in this example determines that the intended TDD DL-UL configuration conflicts with the intended or current TDD DL-UL configuration of the base station 12-2. The base station 12-2 sends a rejection message to the base station 12-1 (step 2002). The rejection message may indicate that the message was rejected because of the intended TDD DL-UL Configuration NR IE received from the base station 12-1. The rejection message may include any value, numeric, alphanumeric, or otherwise to indicate that the cause is an Unacceptable Intended TDD DL-UL Configuration NR IE. In some implementations, the rejection message may include the intended TDD DL-UL configuration or existing TDD DL-UL configuration of the base station 12-2. In the context of cellular communications standards, the rejection message may comprise an XN SETUP FAILURE message.

The base station 12-1 receives the rejection message and determines a new intended TDD DL-UL Configuration NR IE with a different pattern of DL slots and UL slots. The new intended TDD DL-UL Configuration NR IE may be derived, at least in part, based on the intended TDD DL-UL Configuration or existing TDD DL-UL Configuration of the base station 12-2. The base station 12-1 sends another message, such as another XN SETUP REQUEST message, that includes the new intended TDD DL-UL configuration to the base station 12-2 (step 2004). The base station 12-2 receives the message and decides to accept the new intended TDD DL-UL configuration based on the existing or intended TDD DL-UL configuration of the base station 12-2. The base station 12-2 sends the base station 12-1 an acceptance message (step 2006). In the context of cellular communications standards, the acceptance message may comprise an XN SETUP RESPONSE message. In some implementations, the acceptance message may include the intended TDD DL-UL configuration and/or existing TDD DL-UL configuration of the base station 12-2. The base station 12-1 may now begin using the new intended TDD DL-UL configuration of the base station 12-1 to communicate with one or more UEs 20.

In this example, for purposes of illustration, assume that the base station 12-1 determines that the intended TDD DL-UL configuration or existing TDD DL-UL configuration of the base station 12-2 is not acceptable, and sends a reject message to the base station 12-2 (step 2008). The reject message may include the TDD DL-UL configuration of the base station 12-1. This process may continue until the base station 12-1 and the base station 12-2 each accept the intended TDD DL-UL configurations. In some implementations, where the base station 12-1 determines that the TDD DL-UL configuration of the base station 12-2 is not acceptable, the base station 12-1 may not immediately utilize the intended TDD DL-UL configuration of the base station 12-1. For example, the base station 12-1 may not use an intended TDD DL-UL configuration until both the base station 12-1 and the base station 12-2 have agreed that the intended TDD DL-UL configurations are acceptable.

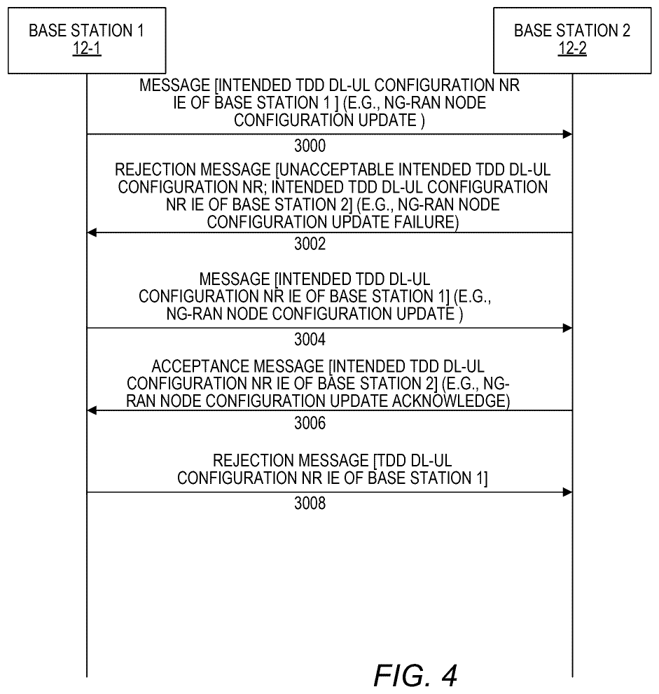

FIG. 4 is a sequence diagram illustrating a message sequence for implementing negotiated TDD DL-UL configurations according to another implementation. A similar sequence as described above with regard to FIG. 3 may occur when the base station 12-1 updates its intended TDD DL-UL configuration because of a change in the number, or quantity, of UEs 20 being serviced, such as might occur when a UE 20 has entered the service area 18 or left the service area 18, or a UE 20 currently being serviced by the base station 12-1 requires more UL slots to send data or more DL slots to receive data. The base station 12-1 sends a message to the base station 12-2 that includes the intended TDD DL-UL configuration (step 3000). In the context of cellular communications standards, such as, by the way of non-limiting example, 3GPP standards, the message may comprise an NG-RAN NODE CONFIGURATION UPDATE message, and the intended TDD DL-UL configuration may be communicated in an intended TDD DL-UL Configuration NR IE of the NG-RAN NODE CONFIGURATION UPDATE message.

The base station 12-2 receives the message and may accept the message or reject the message. An acceptance message, in the context of cellular communications standards, may comprise an NG-RAN NODE CONFIGURATION UPDATE ACKNOWLEDGE message. In some implementations, the base station 12-2 may include an intended TDD DL-UL Configuration NR IE in the NG-RAN NODE CONFIGURATION UPDATE ACKNOWLEDGE message that includes the intended TDD DL-UL configuration of the base station 12-2. Alternatively, the base station 12-2 may reject the message. A rejection message, in the context of cellular communications standards, may comprise an NG-RAN NODE CONFIGURATION UPDATE FAILURE message that includes the intended TDD DL-UL configuration of the base station 12-2.

The rejection message may indicate that the message was rejected because of the intended TDD DL-UL Configuration NR IE received from the base station 12-1. The rejection message may include any value, numeric, alphanumeric, or otherwise to indicate that the cause is an Unacceptable Intended TDD DL-UL Configuration NR IE.

The base station 12-1 receives the rejection message and determines a new intended TDD DL-UL Configuration NR IE. The new intended TDD DL-UL Configuration NR IE may be derived, at least in part, based on the intended TDD DL-UL Configuration or existing TDD DL-UL Configuration of the base station 12-2. The base station 12-1 sends another message, such as another NG-RAN NODE CONFIGURATION UPDATE message, that includes the new intended TDD DL-UL configuration to the base station 12-2 (step 3004). The base station 12-2 receives the message and decides to accept the message based on the existing or intended TDD DL-UL configuration of the base station 12-2. The base station 12-2 sends the base station 12-1 an acceptance message (step 3006). In the context of cellular communications standards, the acceptance message may comprise an NG-RAN NODE CONFIGURATION UPDATE ACKNOWLEDGE message. In some implementations, the acceptance message may include the intended TDD DL-UL configuration and/or existing TDD DL-UL configuration of the base station 12-2. In some implementations, the acceptance message may include the intended TDD DL-UL configuration of the base station 12-1 to indicate to the base station 12-1 that the intended TDD DL-UL configuration of the base station 12-1 is acceptable. The base station 12-1 may now begin using the intended TDD DL-UL configuration of the base station 12-1 to communicate with one or more UEs 20. The base station 12-1 may also determine that the intended TDD DL-UL configuration or existing TDD DL-UL configuration of the base station 12-2 is not acceptable and send a reject message to the base station 12-2 (step 3008). Similar processing as described above with regard to FIG. 3 may then ensue.

It is noted that the intended TDD-DL-UL configuration may be sent by the base station 12-1 on a per served cell basis. Each base station 12 may have multiple cells, such as three cells, and thus the base station 12-1 may send multiple intended TDD-DL-UL configurations to each of the base stations 12-2 and 12-3.

In some implementations it may be preferable for neighboring base stations 12 to agree on using an identical TDD DL-UL configuration. For cells directed away from each other the use of identical TDD DL-UL configurations may be irrelevant because such transmissions may not interfere with one another.

In some implementations, prior to accepting an intended TDD DL-UL configuration received from the base station 12-1, the base station 12-2 may test and/or evaluate the intended TDD DL-UL configuration.

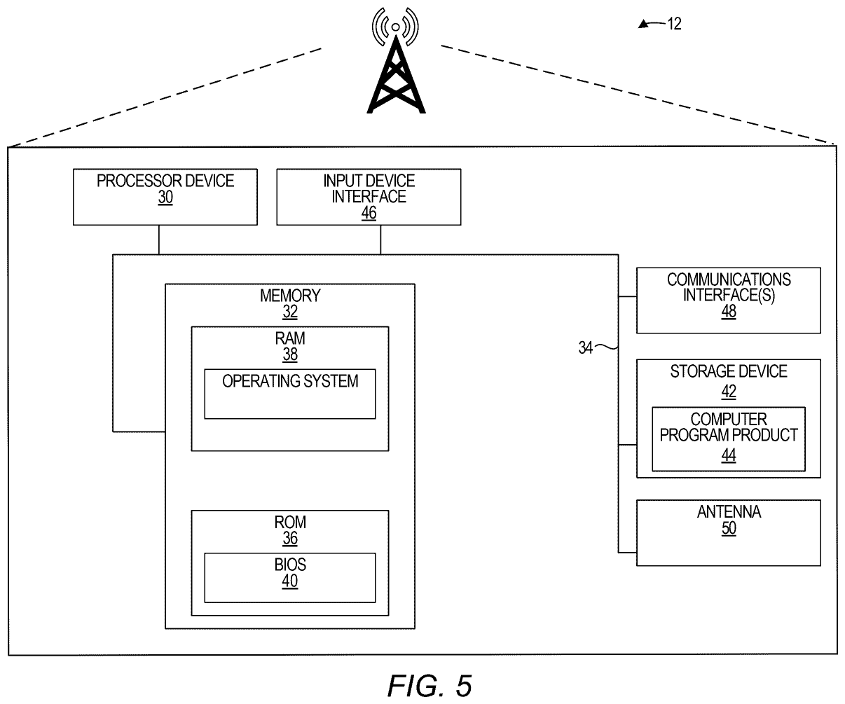

FIG. 5 is a block diagram of a base station 12 suitable for implementing examples according to one example. The base station 12 may comprise any wireless base station capable of including firmware, hardware, and/or executing software instructions to implement the functionality described herein. The base station 12 includes a processor device 30, a system memory 32, and a system bus 34. The system bus 34 provides an interface for system components including, but not limited to, the system memory 32 and the processor device 30. The processor device 30 can be any commercially available or proprietary processor device.

The system bus 34 may be any of several types of bus structures that may further interconnect to a memory bus (with or without a memory controller), a peripheral bus, and/or a local bus using any of a variety of commercially available bus architectures. The system memory 32 may include non-volatile memory 36 (e.g., read-only memory (ROM), erasable programmable read-only memory (EPROM), electrically erasable programmable read-only memory (EEPROM), etc.), and volatile memory 38 (e.g., random-access memory (RAM)). A basic input/output system (BIOS) 40 may be stored in the non-volatile memory 36 and can include the basic routines that help to transfer information between elements within the base station 12. The volatile memory 38 may also include a high-speed RAM, such as static RAM, for caching data.

The base station 12 may further include or be coupled to a non-transitory computer-readable storage medium such as a storage device 42, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 42 and other drives associated with computer-readable media and computer-usable media may provide non-volatile storage of data, data structures, computer-executable instructions, and the like.

A number of modules can be stored in the storage device 42 and in the volatile memory 38, including an operating system and one or more program modules which may implement the functionality described herein in whole or in part. All or a portion of the examples may be implemented as a computer program product 44 stored on a transitory or non-transitory computer-usable or computer-readable storage medium, such as the storage device 42, which includes complex programming instructions, such as complex computer-readable program code, to cause the processor device 30 to carry out the steps described herein. Thus, the computer-readable program code can comprise software instructions for implementing the functionality of the examples described herein when executed on the processor device 30.

An operator may also be able to enter one or more configuration commands through a keyboard (not illustrated), a pointing device such as a mouse (not illustrated), or a touch-sensitive surface such as a display device. Such input devices may be connected to the processor device 30 through an input device interface 46 that is coupled to the system bus 34 but can be connected by other interfaces such as a parallel port, an Institute of Electrical and Electronic Engineers (IEEE) 1394 serial port, a Universal Serial Bus (USB) port, an IR interface, and the like. The base station 12 may also include one or more communications interfaces 48, such as cellular transmitter and receivers, Ethernet transceivers, fiber transceivers, and the like. The base station 12 may also include one or more antennae 50 operable to send and receive wireless signals.

Individuals will recognize improvements and modifications to the preferred examples of the disclosure. All such improvements and modifications are considered within the scope of the concepts disclosed herein and the claims that follow.

What is claimed is:

1. A method, comprising:
sending, by a first wireless base station to a second wireless base station, a first message that includes an intended time division duplex (TDD) downlink (DL)-uplink (UL) configuration of the first wireless base station that identifies a first pattern of uplink timeslots and downlink timeslots that the first wireless base station proposes to utilize to communicate with one or more user equipments (UEs) in a service area of the first wireless base station; and
receiving, by the first wireless base station from the second wireless base station, a second message comprising an acceptance message that accepts the intended TDD DL-UL configuration of the first wireless base station or a rejection message that rejects the intended TDD DL-UL configuration of the first wireless base station.

2. The method of claim 1, wherein the second message comprises the acceptance message and includes an intended TDD DL-UL configuration of the second wireless base station or an existing TDD DL-UL configuration of the second wireless base station.

3. The method of claim 2, further comprising:
in response to the second message comprising the acceptance message, using, by the first wireless base station, the intended TDD DL-UL configuration of the first wireless base station to communicate with the one or more UEs in the service area of the first wireless base station.

4. The method of claim 1, wherein the second message comprises the rejection message and includes an intended TDD DL-UL configuration of the second wireless base station or an existing TDD DL-UL configuration of the second wireless base station.

5. The method of claim 4, further comprising:
in response to the second message comprising the rejection message, not using, by the first wireless base station, the intended TDD DL-UL configuration of the first wireless base station to communicate with the one or more UEs in the service area of the first wireless base station;
generating a new intended TDD DL-UL configuration of the first wireless base station that identifies a second pattern of uplink timeslots and downlink timeslots that the first wireless base station proposes to utilize to communicate with the one or more UEs in the service area of the first wireless base station, wherein the second pattern differs from the first pattern; and
sending, by the first wireless base station to the second wireless base station, a third message that includes the new intended TDD DL-UL configuration of the first wireless base station.

6. The method of claim 1, wherein the first message is sent in response to the first wireless base station initializing.

7. The method of claim 6, wherein the first message comprises a XN SETUP REQUEST message and the intended TDD DL-UL configuration of the first wireless base station is identified in an intended TDD DL-UL Configuration New Radio (NR) Information Element (IE) of the XN SETUP REQUEST message.

8. The method of claim 1, wherein the first message is sent in response to a quantity of the one or more UEs in the service area of the first wireless base station changing.

9. The method of claim 8 wherein the first message comprises an NG-RAN NODE CONFIGURATION UPDATE message and the intended TDD DL-UL configuration of the first wireless base station is identified in an intended TDD DL-UL Configuration NR IE of the NG-RAN NODE CONFIGURATION UPDATE message.

10. The method of claim 1, wherein the second message comprises an XN SETUP RESPONSE message.

11. The method of claim 1, wherein the first wireless base station is a 5G wireless base station or a 6G wireless base station.

12. A first wireless base station, comprising:
a memory; and
a processor device operable to:
send, to a second wireless base station, a first message that includes an intended time division duplex (TDD) downlink (DL)-uplink (UL) configuration of the first wireless base station that identifies a first pattern of uplink timeslots and downlink timeslots that the first wireless base station proposes to utilize to communicate with one or more user equipments (UEs) in a service area of the first wireless base station; and
receive, from the second wireless base station, a second message comprising an acceptance message that accepts the intended TDD DL-UL configuration of the first wireless base station or a rejection message that rejects the intended TDD DL-UL configuration of the first wireless base station.

13. The first wireless base station of claim 12, wherein the second message comprises the acceptance message and includes an intended TDD DL-UL configuration of the second wireless base station or an existing TDD DL-UL configuration of the second wireless base station.

14. The first wireless base station of claim 13, wherein the processor device is further operable to:
in response to the second message comprising the acceptance message, use the intended TDD DL-UL configuration of the first wireless base station to communicate with the one or more UEs in the service area of the first wireless base station.

15. The first wireless base station of claim 12, wherein the second message comprises the rejection message and includes an intended TDD DL-UL configuration of the second wireless base station or an existing TDD DL-UL configuration of the second wireless base station.

16. The first wireless base station of claim 15, wherein the processor device is further operable to:
in response to the second message comprising the rejection message, not use the intended TDD DL-UL configuration of the first wireless base station to communicate with the one or more UEs in the service area of the first wireless base station;
generate a new intended TDD DL-UL configuration of the first wireless base station that identifies a second pattern of uplink timeslots and downlink timeslots that the first wireless base station proposes to utilize to communicate with the one or more UEs in the service area of the first wireless base station, wherein the second pattern differs from the first pattern; and
send, to the second wireless base station, a third message that includes the new intended TDD DL-UL configuration of the first wireless base station.

17. The first wireless base station of claim 12, wherein the first message is sent in response to the first wireless base station initializing.

18. The first wireless base station of claim 17, wherein the first message comprises a XN SETUP REQUEST message and the intended TDD DL-UL configuration of the first wireless base station is identified in an intended TDD DL-UL Configuration New Radio (NR) Information Element (IE) of the XN SETUP REQUEST message.

19. The first wireless base station of claim 12, wherein the first message is sent in response to a quantity of the one or more UEs in the service area of the first wireless base station changing.

20. A non-transitory computer-readable storage medium that includes executable instructions operable to cause a processor device of a first wireless base station to:
send, to a second wireless base station, a first message that includes an intended time division duplex (TDD) downlink (DL)-uplink (UL) configuration of the first wireless base station that identifies a first pattern of uplink timeslots and downlink timeslots that the first wireless base station proposes to utilize to communicate with one or more user equipments (UEs) in a service area of the first wireless base station; and
receive, from the second wireless base station, a second message comprising an acceptance message that accepts the intended TDD DL-UL configuration of the first wireless base station or a rejection message that rejects the intended TDD DL-UL configuration of the first wireless base station.
